(19) United States
(12) Patent Application Publication
(10) Pub. No.: US 2014/0372423 A1
(43) Pub. Date: Dec. 18, 2014

(54) PERSONALIZED ENTITY PREFERENCES MODEL AND NOTIFICATIONS

(71) Applicant: Microsoft Corporation, Redmond, WA (US)

(72) Inventors: Rangan Majumder, Redmond, WA (US); Kyrylo Tropin, Redmond, WA (US); Türker Keskinpala, Redmond, WA (US); Karan Singh Rekhi, Bellevue, WA (US)

(21) Appl. No.: 13/916,853

(22) Filed: Jun. 13, 2013

(51) Int. Cl. G06F 17/30

(52) U.S. Cl. CPC G06F 17/30867; G06F 17/30551
USPC 707/725

(57) ABSTRACT

Architecture that performs the automatic modeling of user preferences for entities (a personal entity preference model) based on user's actions such as search history and temporal search behavior to determine content on the web relevant and of interest to a given user at any given time. Explicit and implicit user responses (e.g., notification clicks, ignore, dismiss, unsubscribe, notification dwell) are used to update the model of user entity preferences. The user entity preference model is used to order notifications based on predicted relevance. Additionally, the user personal entity preference model and implicit responses of user are used to decide timing and frequency of notifications.

### BACKGROUND

Users issue millions of search queries on search engines every day. If a user wants to follow information related to a given entity, in existing implementations the user is typically forced to navigate to various websites in the hope of obtaining the desired entity information. However, this approach is time consuming and not guaranteed to produce the desired information, further making search an exasperating experience.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture enables a user to either explicitly or implicitly select entities of interest and the information of those entities is delivered directly to the user. The is accomplished by the automatic modeling of user preferences for entities (a personal entity preference model) based on user's actions such as search history and temporal search behavior to determine content on the web relevant and of interest to a given user at any given time.

Explicit and implicit user responses (e.g., notification clicks, ignore, dismiss, unsubscribe, notification dwell) are used to update the model of user entity preferences. The user entity preference model is used to order notifications based on predicted relevance. Additionally, the user personal entity preference model and implicit responses of user are used to decide timing and frequency of notifications.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system in accordance with the disclosed architecture.

FIG. 2 illustrates a system of personal entity preference model creation and maintenance in accordance with the disclosed architecture.

FIG. 3 illustrates a notification listing as automatically presented on a computing desktop.

FIG. 4 illustrates an exemplary landing page for personalized entity notifications based on predicted relevance.

FIG. 5 illustrates an exemplary landing page for personalized entity notifications based on predicted relevance.

FIG. 6 illustrates a notification listing that enables content preview on a per entity basis.

FIG. 7 illustrates a method in accordance with the disclosed architecture.

FIG. 8 illustrates an alternative method in accordance with the disclosed architecture.

FIG. 9 illustrates a block diagram of a computing system that executes creation and maintenance of a personalized entity preference model and entity predicted relevance in accordance with the disclosed architecture.

### DETAILED DESCRIPTION

The disclosed architecture performs the automatic modeling of user preferences for entities (a personal entity preference model) based on user's actions such as search history and temporal search behavior to determine content on the web relevant and of interest to a given user at any given time. Explicit and implicit user responses (e.g., notification clicks, ignore, dismiss, unsubscribe, notification dwell) are used to update the model of user entity preferences. The user entity preference model is used to order notifications based on predicted relevance. Additionally, the user personal entity preference model and implicit responses of user are used to decide timing and frequency of notifications.

Since users issue millions of search queries on search engines every day, the personal entity preference model improves on the searches for a given user by filtering out unwanted (non-relevant) entities and results, and providing only results of a predicted relevance. Thus, if the user is more interested in certain entities, only the results deemed (predicted) to be relevant are returned and presented to the user. For example, one implementation of the model, the user entities modeled can include websites the user regularly searches (e.g., often due to regular new content like television shows, lottery websites, and preferred news websites), celebrities of interest the user frequently searches (e.g., for news, social network updates, new videos and photos, etc.), stocks and stock quotes the user regularly searches, prominent search categories that the given user's queries typically map to (e.g., adult, technology, business, etc.), and entities the user has explicitly opted to “like” on social networks (e.g., celebrity fan pages), and so on.

A user is then sent personalized notifications whenever there is content on the Internet or other networks (e.g., news, trending pages, videos, photos, social updates) that maps on to user's entity preference model. Notification can take multiple forms from which the users can opt in or opt out: emails, icons, search applications for mobile devices, search applications operating systems, search applications on various social networking platforms, websites, etc. An icon can be presented that highlights the number of new notifications with a notifications dropdown that appears on user interaction (e.g., button click, touch, etc.).

Users can explicitly opt into or subscribe to follow any specific entity. This act of following a given entity can boost the entity's importance in the entity preference model. Similarly, the user's response (e.g., click, ignore, dismiss, unsubscribe, etc.) to the recommendations included in the notification can be used to alter and update the user's entity preference model and also improve ordering, timing and frequency of the notifications.

The user may interact with a user interface via a natural user interface (NUI) technology suited for a given device. NUI may be defined as any interface technology that enables a user to interact with a device in a “natural” manner, free from artificial constraints imposed by input devices such as mice, keyboards, remote controls, and the like. Examples of NUI methods include those methods that employ gestures, broadly defined herein to include, but not limited to, speech recognition, touch recognition, stylus recognition, gesture recognition both on screen and adjacent to the screen, air gestures, head and eye tracking, voice and speech utterances, and machine learning related at least to vision, speech, voice, pose, and touch data.

NUI technologies include, but are not limited to, touch sensitive displays, voice and speech recognition, intention and goal understanding, motion gesture detection using depth cameras (e.g., stereoscopic camera systems, infrared camera systems, color camera systems, and combinations thereof), motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (e.g., electro-encephalograph (EEG)) and other neuro-biofeedback methods.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

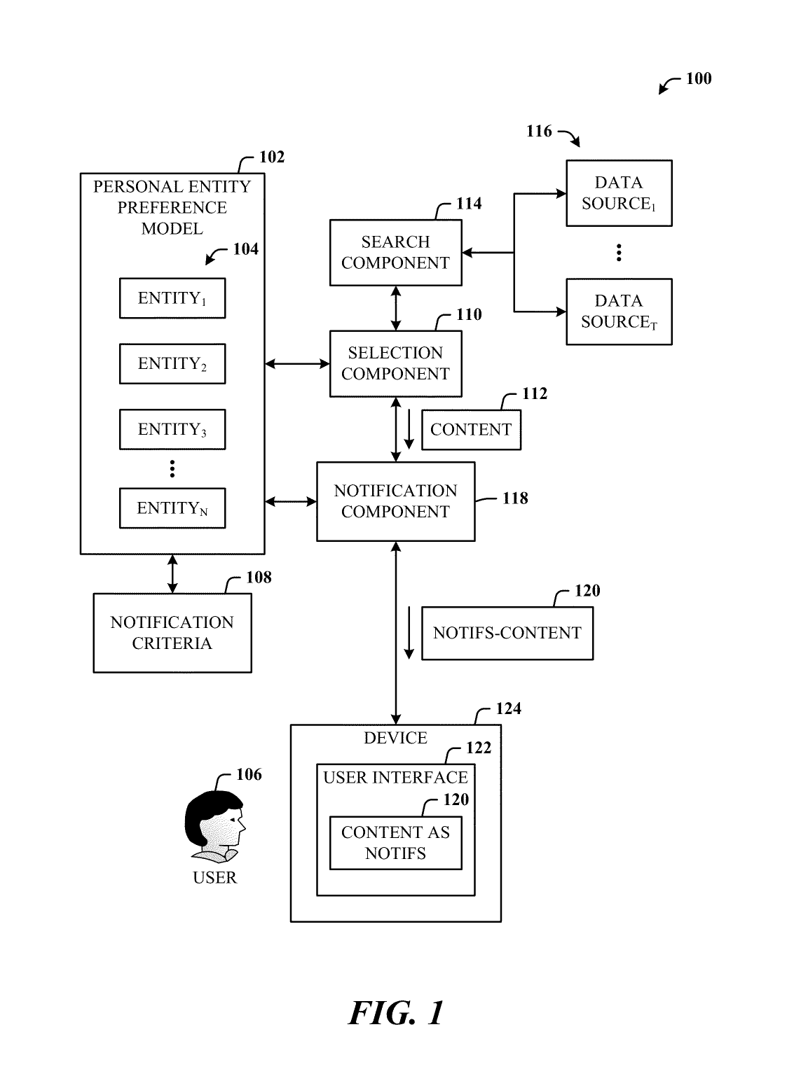

FIG. 1 illustrates a system 100 in accordance with the disclosed architecture. The system 100 can include a personal entity preference model 102 of entities 104 (e.g., selected, searched, viewed, etc.) of a user 106 accessed according to user notification criteria 108. A selection component 110 selects content 112 for each of the entities 104, where the content 112 is obtained from a search (via a search component 114 (e.g., a search engine) searching over different data sources 116 (e.g., the Internet, social networks, local application documents, etc.). The content 112 is selected based on predicted relevance to the user notification criteria 108. A notification component 118 sends the content 112 to the user as notifications 120 (also abbreviated as NOTIFS in the drawings) for presentation of the content 112 (in a user interface 122 of a user device 124).

The personal entity preference model 102 can be automatically created for the user—the user no longer needs to manually tag, list, or indicate in any way entities of interest, etc., although this can be accommodated. The model 102 of user preferences for entities can be automatically created and updated based on user search history and temporal search behavior (times of searches, frequency of searches, etc.), for example, to determine content (e.g., on the Internet) that is relevant and of interest to the given user at any point in time.

The model 102 can be updated (adding new entities, aging out old entities, etc.) using explicit and implicit user responses (interactions or lack thereof). These responses include, but are not limited to, notification clicks (a user selection of an item of content in a notification listing that navigates the user to the webpage associated with the content item), ignore (no interaction with an item of content in a notification listing), dismiss (a deletion interaction on an item of content in the notification listing), unsubscribe (a user interaction interpreted as no longer choosing to follow or track a specific entity), notification dwell (the time duration that the user interacts with the notification listing and/or an item of the notification listing).

The personal entity preference model 102 can be used to order (rank) the notifications 120 based on predicted relevance. Thus, if at a given point in time, it is predicted that the user wants to see content for a specific entity, that entity will be ranked higher than other entities. This ranking can be among entity categories (e.g., cars, celebrities, places, etc.) or of entities within a specific entity category (e.g., Celebrity-1, Celebrity-2, etc., under the category of celebrities).

The model 102 comprises a wide variety of user preferences information such as a set of entities the user chooses to view over other entities. The notification preferences can change over time and for given circumstances (environment) in which the user 106 is located or operating. For example, while a high ranked entity of interest at the end of a work day may be road conditions on the route home, once the user is satisfied the road conditions are known, user interaction (which can include user location as obtained implicitly) can be interpreted to change the preferences to another entity such as dining places along the route taken to get home, for example.

Using the entity preference model 102 and implicit responses of the user, the timing and frequency of the notifications 120 can be computed. As in the previous example, the timing relates to the time of day (end of work day), the implicit response(s) include the user geographic location (e.g., as detected by latitude/longitude coordinate technologies), and the frequency is one—the notification of a place to dine is sent only once. It is possible, however, to increase the frequency of the dining notification to multiple times based on how long it is taking the user to travel the route home, if the user has dined at any number of places along the route in the past, if the user enjoyed particular dining establishments along the route, etc.

Thus, as the user travels the route home, a notification (and content) can be automatically pushed to the user (user device(s) such as vehicle display system, vehicle navigation system, user smartphone, portable computer, etc.) for each preferred dining place the user will approach along the route. The notification can include dining specials for each place, and in particular, specials the user may like. Should the user not choose to dine at a first place, this implicit “ignore” response for this entity will also be noted and updated in the entity preference model 102 for this place, time, date, etc. If the user then selects a second dining place (e.g., as indicated by geographic location data or check-in data), this entity will be updated accordingly in the preferences model 102 as well.

If the user repeats this dining process along this route over time, this will be noted in the preferences model 102, and it can be the case that a notification of a specific restaurant along this route will no longer be ranked sufficiently high to be sent in a notification to the user, since the use has a recent history of avoiding that place.

The entity preference model 102 can also be used to identify trends in user behavior. For example, the trend in the above example may be that the user is now determined to routinely choose to avoid the first dining place on the way home. The first dining place may be a seafood restaurant, and the reason for avoidance by the user is that the user recently has switched to a vegetarian cuisine. Thus, the entity for the first dining place may be significantly reduced in importance or entirely aged out of (deleted from) the model 102; however, should the user choose to then go back to a seafood diet, this can be identified by the updating of the model 102, and hence, the identified trend is that the entity of the first dining place now being elevated in rank (for predicted relevance), and the trend is that the user is now frequenting or tends to frequent the first dining place more than the vegetarian restaurant. Accordingly, the predicted relevance of the vegetarian restaurant is reduced when the user is traveling home along this route.

Thus, the personal entity preference model 102 is automatically created based on at least user search history (on identifiable user devices or as associated with a user account or login credentials) and temporal search behavior (e.g., when the user searches, how often the user searches, etc.) of the user. The notification component 118 orders the notifications 120 based on the predicted relevance and/or the preference model 102. The notification component 118 computes timing and frequency of the notifications 120 based on the personal entity preference model 102 and responses of the user 106. The personal entity preference model 102 is updated based on user responses to content 112 of the notifications 120. The notification component 118 sends the notifications 120 for automatic viewing in a user interface (e.g., a browser, a desktop application, etc.) of a user device (e.g., smartphone, television, game display, desktop computer, portable computer, tablet, etc.). The personal entity preference model 102 enables identification of a specific entity (e.g., a second entity, Entity₂) to track.

Note that although illustrated as separate from the preference model 102, the notification criteria 108 can be part of the model 102. Moreover, the model 102, selection component 110, and the notification component 118, and the notification criteria 108, can be a separate backend system that interfaces to a search engine to query and receive content from which the content 112 can be selected. The content ranking can be performed by the search engine such that the selection component 110 then includes an algorithm that selects the content 112 predicted to be relevant and of interest to the user at any point in time.

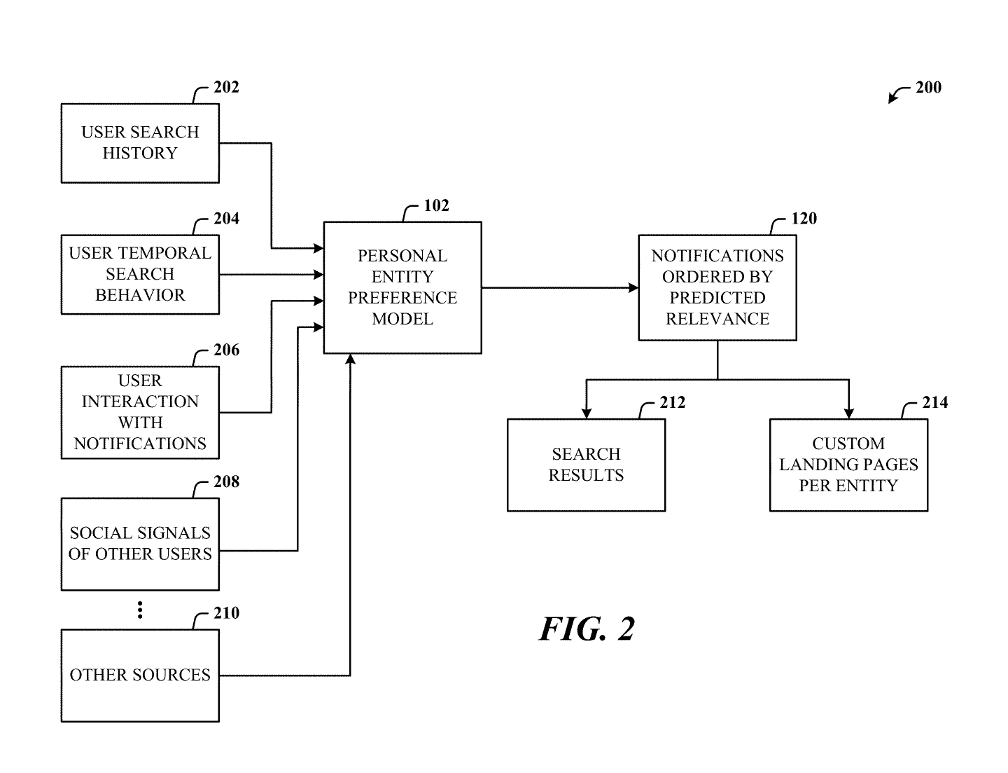

FIG. 2 illustrates a system 200 of personal entity preference model 102 creation and maintenance in accordance with the disclosed architecture. The system 200 utilizes user search history 202, temporal search behavior 204, user interaction with notifications 206 (and notification content), social signals of other users 208, and other sources 210. The user search history 202 can be obtained not only from a browser (of many different user devices) for search activity of a network (e.g., the Internet, intranet, enterprise, etc.), but also from local device searches where the user may be searching for files related to specific entities, such as images, audio, videos, application documents, etc., stored on a user device.

The temporal search behavior 204 includes, but is not limited to, any searches and search results related to time (e.g., of day, day of the week, etc.), spans of time (e.g., over a two week span), frequency of searches (searches made in one hour, day, etc.), frequency of the same or similar search, the time spent on content (the dwell), the time not spent on content (lack of dwell), the time between searches, and so on.

The user interaction with notifications 206 includes, but is not limited to, if the user interacted with notification content, did not interact with the content, how the user interacted with the content (e.g., by physical input device (e.g., mouse, keypad), by touch-based display, by voice command, by speech, by air gestures, and other recognition technologies, etc.), the action taken or not taken on the content (e.g., click-through to the associated webpage, delete the content, readjust the ranking of the content in the notification listing, close the listing in the user interface without notification item selection, etc.), configure direct play of multimedia content (e.g., a video, music, etc.) in the notification listing rather than providing a link to the landing webpage (a single webpage associated with selection of a hyperlink, e.g., a search result), and so on.

The social signals of other users 208 can include, but are not limited to, entity information of the other users, trending entities of social networks, entities of other users and other users the current user indicates in the user's entity preference model 102 to follow, specific websites to access as might be indicated in a ranked way in the model 102 by the user or other users, and so on.

The other sources 210 can include, but are not limited to, websites that provide environmental information, construction information, geographic information, maps, weather information, road condition information, traffic information, celebrity information, stock market information, business information, technology information, general local, regional, national, and international news information, flight information, travel information, parking information, event information, user emails, user text messages, and so on.

This information (202, 204, 206, 208, and 210) about entities is then computed to create the preferences model 102. The output of the model 102 is then used not only to create the notifications 120 based on predicted relevance but to facilitate ordering the notifications 120 as well, by predicted relevance, for example. The order of the notifications 120 is then applied to the search results 212 and the notifications 120 are linked to custom landing pages 214 on a per entity basis.

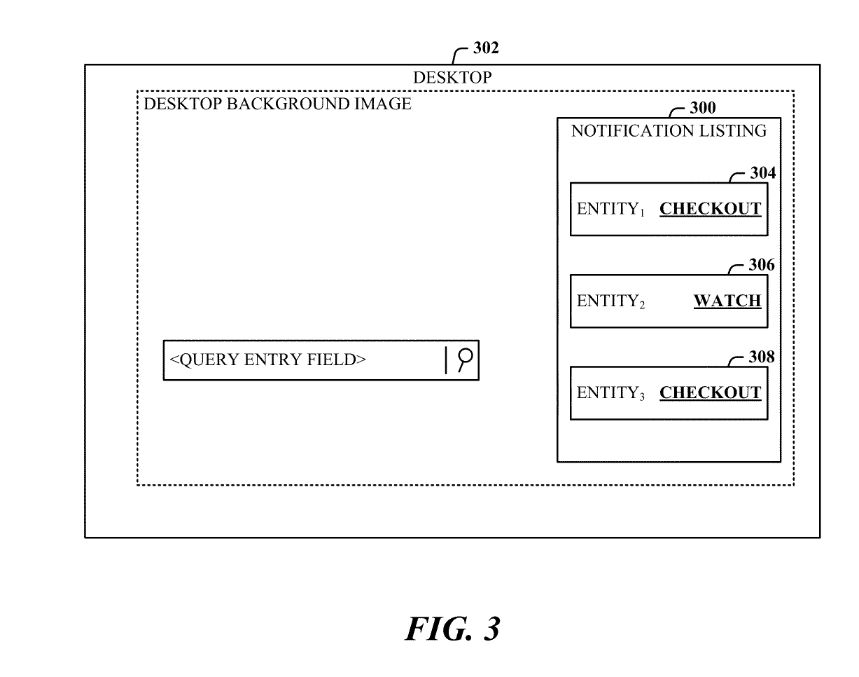

FIG. 3 illustrates a notification listing 300 as automatically presented on a computing desktop 302. The listing 300 is an ordered listing of entities selected as predicted to be relevant at any point in time. Each entity of the listing 300 is a notification. Thus, the notification listing 300 may have only a single notification for an entity of interest to the user as being predictably relevant to the user at a given time. Here, three predictably relevant entities (as separate notifications) are presented: a first entity 304 (Entity₁), a second entity 306 (Entity₂), and a third entity 308 (Entity₃). The first entity 304 can be ranked at the top of the listing 300 because the user has indicated, through interactions (implicit and/or explicit) as noted in the preferences model 102, that the user desires to see the first entity 304 more than the other entities. It can be the case that the first entity 304 is also the top ranked entity (e.g., Celebrity-1) (highest predicted relevance) in the category (celebrities) of entities (Celebrity-2, Celebrity-3, Celebrity-4, Celebrity-1). Thus, only Celebrity-1 content (e.g., image, title, short summary) is shown in the listing 300 for this entity category. This predicted relevance can be by entity category (Entity₁ ranked higher than Entity₂) and entity in a category (e.g., Celebrity-1 more predictably relevant than Celebrity-2). The notification for the first entity 304 also include an interactive control (“Checkout”) the user can select to navigate to the webpage (landing page) for this entity (Celebrity-1).

The second entity 306 can be relevant to a television program or movie, for example. The notification for the second entity 306 is presented second in the listing 300 since it is deemed less predictably relevant than the first entity 304. Given that the second entity 306 is related to shows or movies, a “Watch” control can be presented as part of the content along with the specific program image, a short title, and brief description text. The control enables the user to immediately link to the landing page for this entity or watch it in a reduced screen sized mode.

Similarly, the notification for the third entity 308 is presented third in the listing 300 since it is deemed less predictably relevant than the first entity 304 and the second entity 306. Where the third entity 308 is a lottery drawing, a “Checkout” control can be presented as part of the content along with the specific lottery emblem, a short title, and brief description text.

It can be the case that a fourth entity (not shown) relates to online games, in which instance the notification (also referred to as a notification item) can include a game image, game title, textual information to prompt the user to play, and a “Play” control that automatically links the user to the game landing page to subscribe to or begin playing the game, for example. The user can close the notification listing 300 or drag-and-drop it to any location on the desktop, as desired.

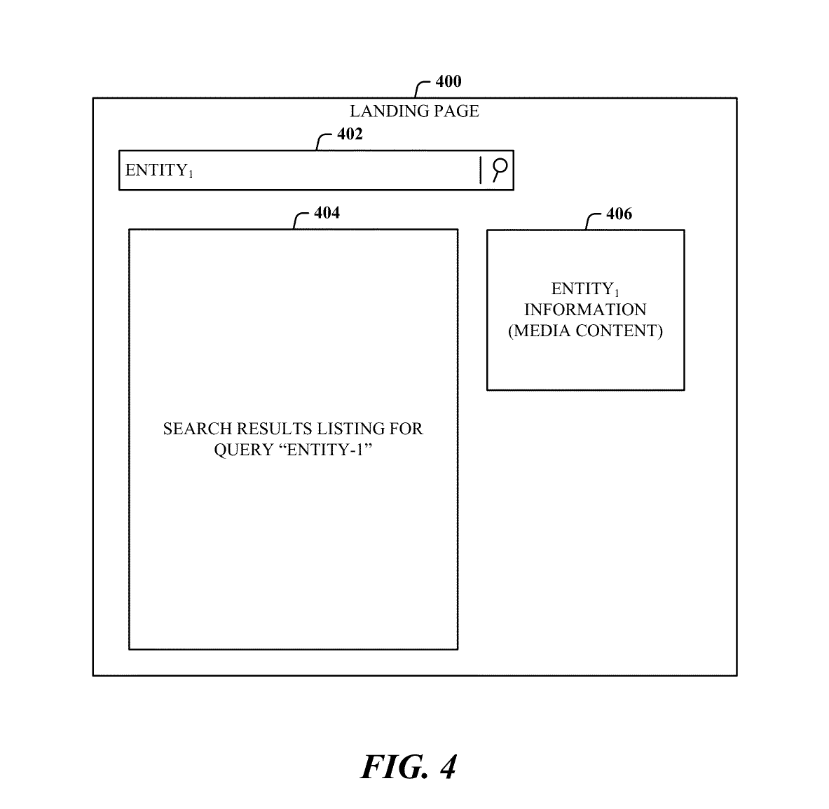

FIG. 4 illustrates an exemplary landing page 400 for personalized entity notifications based on predicted relevance. The landing page 400 is the webpage the user is directed to when interacting with a link (or control) in the notification item of the notification listing 300. The landing page 400 shows the entity (e.g., Entity₁) as the search query in a query input field 402, and the search results 404 returned for the query. Additionally, the landing page 400 now also shows additional entity information 406 such as predicted relevant media content and related searches about the entity of interest to the user. For example, predicted relevant video content to the entity can be played and viewed directly in this webpage area allocated for the additional entity information 406. All of this landing page information/content is personalized to the user as related to the Entity₁.

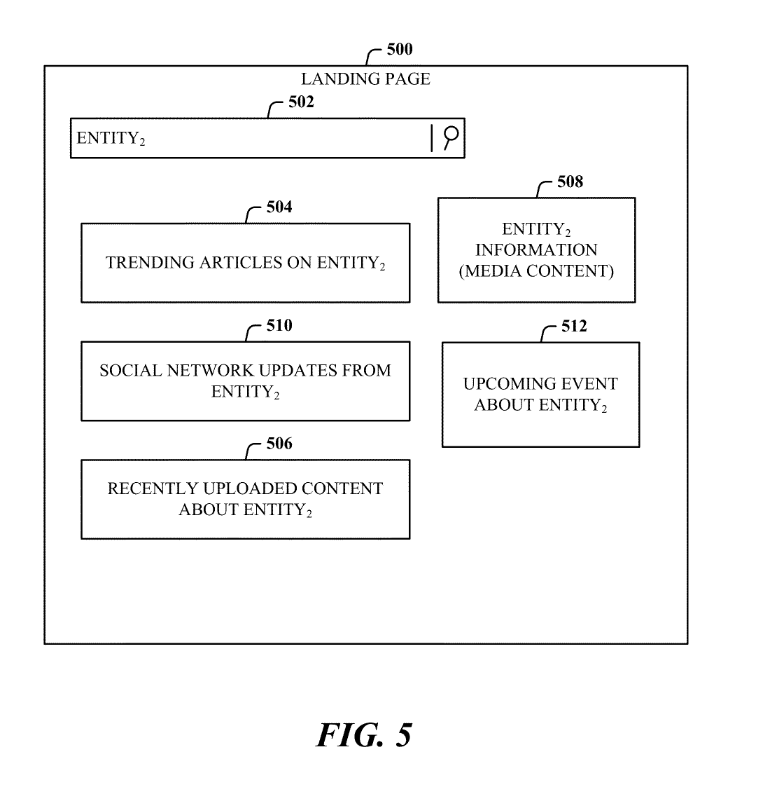

FIG. 5 illustrates an exemplary landing page 500 for personalized entity notifications based on predicted relevance. The landing page 500 is the webpage the user is directed to when interacting with a link (or control) in the notification item of the notification listing 300. The landing page 500 shows the entity (e.g., Entity₂) as the search query in a query input field 502, a trending articles section 504, recently uploaded content section 506 and additional entity information 508.

Additionally, in the context of a celebrity entity, for example, the landing page 500 now also shows a social network updates section 510 and an upcoming event information section 512 as predicted to be relevant information to the interest of the user for this entity. The social network updates section 510 receives/obtains social network information from one or more social networks. Again, all of this landing page information/content is personalized to the user as related to the Entity₂.

The disclosed architecture can employ a privacy component (not shown) for authorized and secure handling of user information. The privacy component enables the user to opt-in and opt-out of tracking user search behavior as relates to any application or user action. The user can be provided with notice of the collection of personal information, for example, and the opportunity to provide or deny consent to do so. The privacy component also enables the user to access and update profile information. For example, the user can view the personal and/or tracking data that has been collected, and provide corrections.

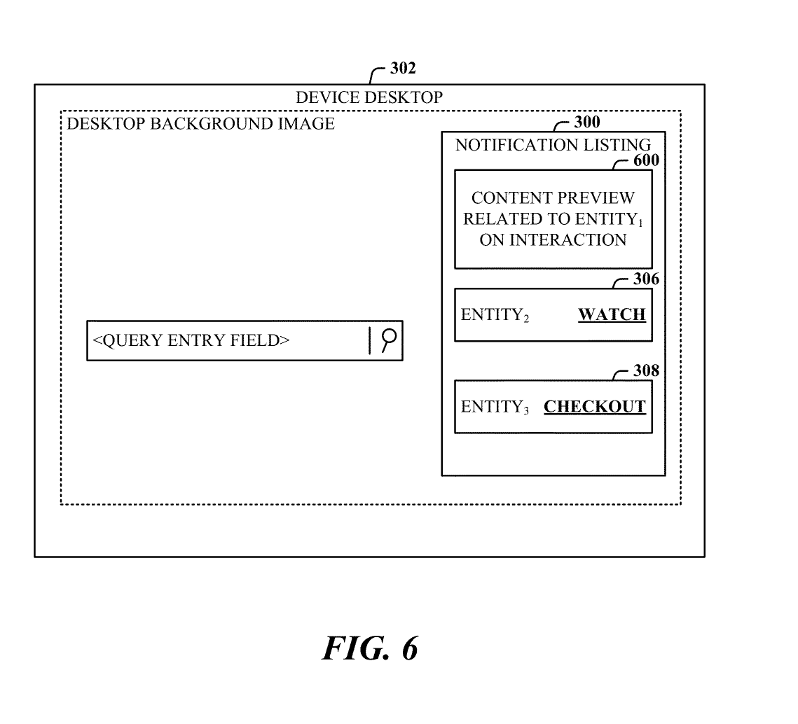

FIG. 6 illustrates a notification listing 300 that enables content preview on a per entity basis. Referring to the notification item for the first entity 304 (of FIG. 3), a content preview 600 can be enabled based on the user interaction with the entity. If the first entity 304 is for a specific celebrity, Celebrity-1, in response to hover-over by a mouse pointer (or gesture-based input such as a touch), for example, the entity item switches to a preview mode to show a content preview for the entity. The preview content can be obtained from the associated landing page to which the entity item in the notification listing is linked. In the case of the preview content being a video, it can further be the case that the user can interact with the preview content to play the video.

In a stock example, hover-over can result in the preview content being a stock graph for a specific stock, such that the user can see stock price variations over time (e.g., the past month). The stock preview content can also show active (realtime) stock quote information based on the hover-over action. The user can then select the preview content, which results in the user navigating to the associated stock entity landing page.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

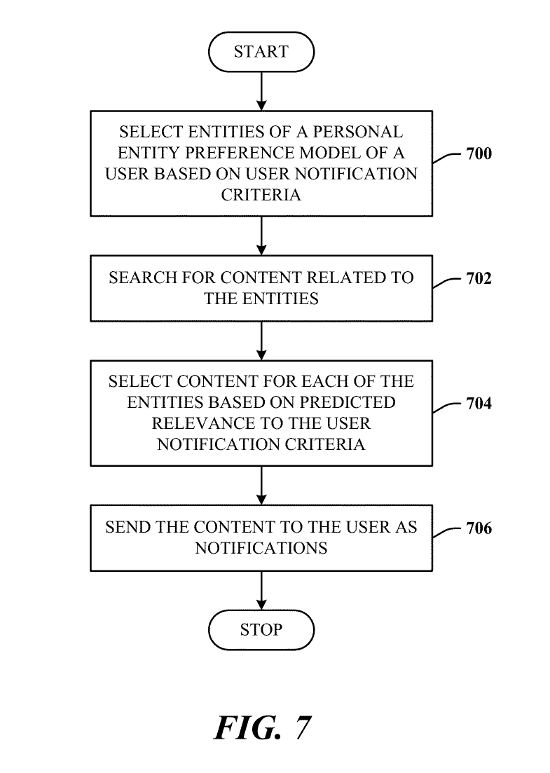

FIG. 7 illustrates a method in accordance with the disclosed architecture. At 700, entities of a personal entity preference model of a user are selected based on user notification criteria. The model comprises entities of personal interest to the user. The entities can all be of a single entity category (e.g., celebrities) and/or entities across multiple categories (e.g., entities such as a specific Celebrity, a specific Movie, a specific SportsTeam, a specific StockQuote, etc.). The user notification criteria includes but is not limited to the location of the user, time of day, day of week, heading of the user, travel speed, search behavior on a device or multiple devices, environmental conditions (e.g., weather, road construction, detours, traffic conditions, etc.), specifically tagged entities to follow, and so on. The model itself is automatically created and maintained (updated).

At 702, content related to the entities is searched. The entity can be searched on the Internet and social websites, for example, using a search engine to obtain information (e.g., the most recent, prior information, etc.) about the entity. At 704, content for each of the entities is selected based on predicted relevance to the user notification criteria. The results returned are deemed relevant, but some results or content is computed to be more relevant than other results or content.

At 706, the content is sent to the user as notifications. The content computed (predicted) to be the most relevant at any point in time is then sent to the user interface of the user device for presentation. The notifications (for each entity item) can be aggregated as the notification listing that pops-up periodically in the user interface, whatever that may be. This listing can be configured to automatically display based on a user preferences setting, such as in response to receiving a new content update for an entity, location of the user, the particular device currently in use by the user, new content update based on a notification rank in the listing (if ranked lower, new content obtained will not trigger pop-up of the new listing, whereas the top ranked notification listed the notification will not.

The method can further comprise ordering the notifications (items in the listing) based on the personal entity preference model. The method can further comprise automatically creating the personal entity preference model based on search history and temporal search behavior of the user. The method can further comprise computing timing and frequency of the notifications to the user (user device) based on the personal entity preference model.

The method can further comprise updating the personal entity preference model using explicit and implicit user responses to same or different entities. The method can further comprise updating the personal entity preference model based on a user response to a notification. For example, if the user never interacts with a notification item in the listing, it can be inferred that the item is of lesser interest and may not be subsequently predicted to be relevant in the listing. The method can further comprise automatically linking (in response to interacting with a hyperlink) to the content for the entities on the user device via the notifications. The method can further comprise automatically presenting the content for the entities on the user device. The trigger for the presentation can be based on a user setting, user location, particular user device, time of day, etc.

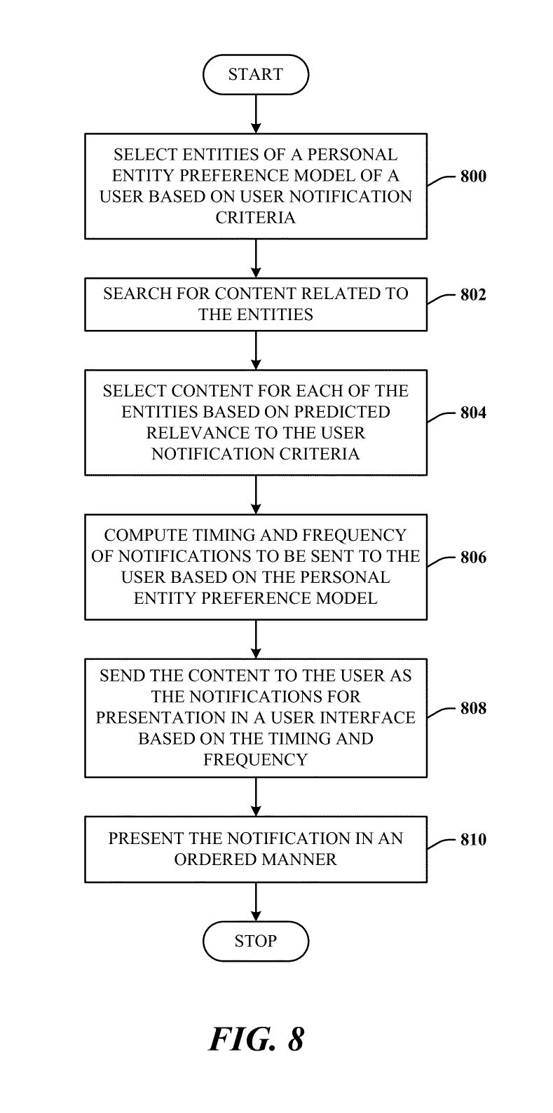

FIG. 8 illustrates an alternative method in accordance with the disclosed architecture. At 800, entities of a personal entity preference model of a user are selected based on user notification criteria. At 802, content related to the entities is searched. At 804, content for each of the entities is selected based on predicted relevance to the user notification criteria. At 806, timing and frequency of notifications to be sent to the user is computed based on the personal entity preference model. At 808, the content is sent to the user as the notifications for presentation in a user interface based on the timing and frequency. At 810, the notifications are presented in an ordered manner. The notification items in the listing can be ranked according to the user interest.

The method can further comprise automatically linking to the content for the entities via the notifications or automatically presenting the content for the entities on the user device. The method can further comprise automatically creating the personal entity preference model based on search history and temporal search behavior of the user. The method can further comprise updating the personal entity preference model using explicit and implicit user responses to same or different entities. The method can further comprise updating the personal entity preference model based on a user response to content of a notification.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in a volatile or a non-volatile storage medium), a module, a thread of execution, and/or a program.

By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

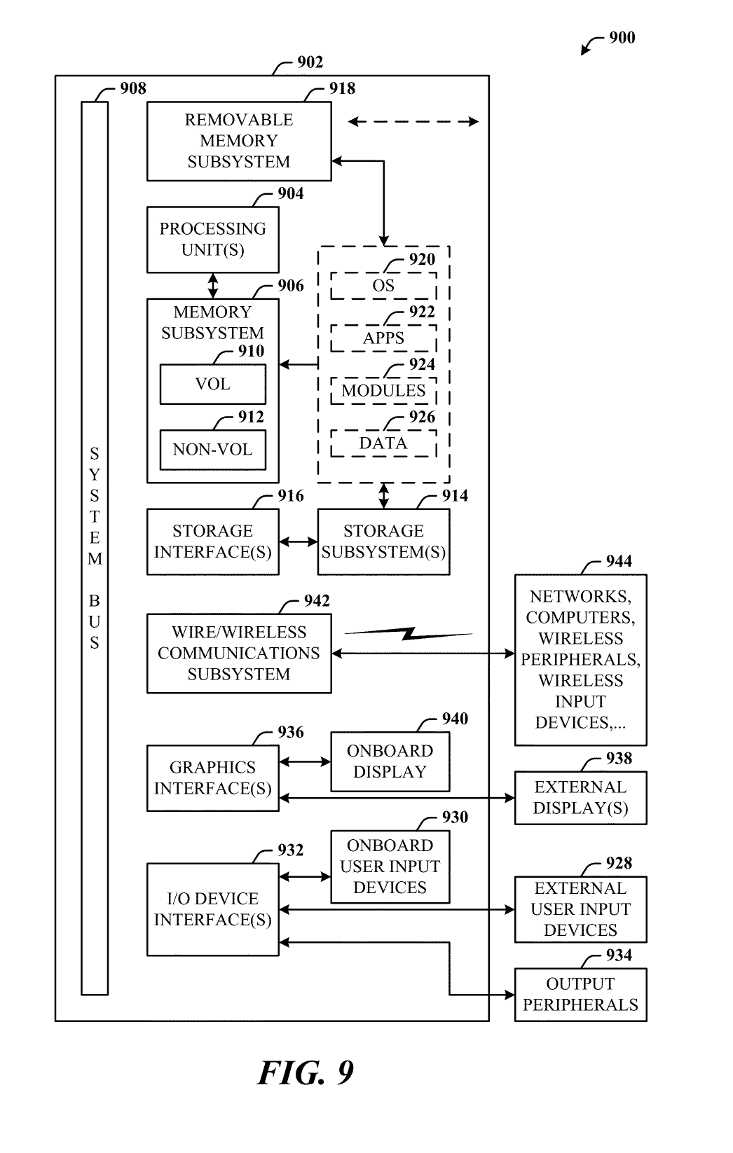

Referring now to FIG. 9, there is illustrated a block diagram of a computing system 900 that executes creation and maintenance of a personalized entity preference model and entity predicted relevance in accordance with the disclosed architecture. However, it is appreciated that the some or all aspects of the disclosed methods and/or systems can be implemented as a system-on-a-chip, where analog, digital, mixed signals, and other functions are fabricated on a single chip substrate.

In order to provide additional context for various aspects thereof, FIG. 9 and the following description are intended to provide a brief, general description of the suitable computing system 900 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 900 for implementing various aspects includes the computer 902 having processing unit(s) 904 (also referred to as microprocessor(s) and processor(s)), a computer-readable storage medium such as a system memory 906 (computer readable storage medium/media also include magnetic disks, optical disks, solid state drives, external memory systems, and flash memory drives), and a system bus 908. The processing unit(s) 904 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, tablet PC, etc.), hand-held computing devices, microprocessor-based or programmable consumer electronics, and the like, each of which can be operatively coupled to one or more associated devices.

The computer 902 can be one of several computers employed in a datacenter and/or computing resources (hardware and/or software) in support of cloud computing services for portable and/or mobile computing systems such as cellular telephones and other mobile-capable devices. Cloud computing services, include, but are not limited to, infrastructure as a service, platform as a service, software as a service, storage as a service, desktop as a service, data as a service, security as a service, and APIs (application program interfaces) as a service, for example.

The system memory 906 can include computer-readable storage (physical storage) medium such as a volatile (VOL) memory 910 (e.g., random access memory (RAM)) and a non-volatile memory (NON-VOL) 912 (e.g., ROM, EPROM, EEPROM, etc.). A basic input/output system (BIOS) can be stored in the non-volatile memory 912, and includes the basic routines that facilitate the communication of data and signals between components within the computer 902, such as during startup. The volatile memory 910 can also include a high-speed RAM such as static RAM for caching data.

The system bus 908 provides an interface for system components including, but not limited to, the system memory 906 to the processing unit(s) 904. The system bus 908 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 902 further includes machine readable storage subsystem(s) 914 and storage interface(s) 916 for interfacing the storage subsystem(s) 914 to the system bus 908 and other desired computer components. The storage subsystem(s) 914 (physical storage media) can include one or more of a hard disk drive (HDD), a magnetic floppy disk drive (FDD), solid state drive (SSD), and/or optical disk storage drive (e.g., a CD-ROM drive DVD drive), for example. The storage interface(s) 916 can include interface technologies such as EIDE, ATA, SATA, and IEEE 1394, for example.

One or more programs and data can be stored in the memory subsystem 906, a machine readable and removable memory subsystem 918 (e.g., flash drive form factor technology), and/or the storage subsystem(s) 914 (e.g., optical, magnetic, solid state), including an operating system 920, one or more application programs 922, other program modules 924, and program data 926.

The operating system 920, one or more application programs 922, other program modules 924, and/or program data 926 can include items and components of the system 100 of FIG. 1, items and components of the system 200 of FIG. 2, the notification listing 300 of FIG. 3, the exemplary landing page 400 of FIG. 4, the exemplary landing page 500 of FIG. 5, the notification listing 300 with content preview of FIG. 6, and the methods represented by the flowcharts of FIGS. 7 and 8, for example.

Generally, programs include routines, methods, data structures, other software components, etc., that perform particular tasks or implement particular abstract data types. All or portions of the operating system 920, applications 922, modules 924, and/or data 926 can also be cached in memory such as the volatile memory 910, for example. It is to be appreciated that the disclosed architecture can be implemented with various commercially available operating systems or combinations of operating systems (e.g., as virtual machines).

The storage subsystem(s) 914 and memory subsystems (906 and 918) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage medium/media, regardless of whether all of the instructions are on the same media.

Computer readable storage media (medium) exclude (excludes) propagated signals per se, can be accessed by the computer 902, and include volatile and non-volatile internal and/or external media that is removable and/or non-removable. For the computer 902, the various types of storage media accommodate the storage of data in any suitable digital format. It should be appreciated by those skilled in the art that other types of computer readable medium can be employed such as zip drives, solid state drives, magnetic tape, flash memory cards, flash drives, cartridges, and the like, for storing computer executable instructions for performing the novel methods (acts) of the disclosed architecture.

A user can interact with the computer 902, programs, and data using external user input devices 928 such as a keyboard and a mouse, as well as by voice commands facilitated by speech recognition. Other external user input devices 928 can include a microphone, an IR (infrared) remote control, a joystick, a game pad, camera recognition systems, a stylus pen, touch screen, gesture systems (e.g., eye movement, head movement, etc.), and/or the like. The user can interact with the computer 902, programs, and data using onboard user input devices 930 such a touchpad, microphone, keyboard, etc., where the computer 902 is a portable computer, for example.

These and other input devices are connected to the processing unit(s) 904 through input/output (I/O) device interface(s) 932 via the system bus 908, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 932 also facilitate the use of output peripherals 934 such as printers, audio devices, camera devices, and so on, such as a sound card and/or onboard audio processing capability.

One or more graphics interface(s) 936 (also commonly referred to as a graphics processing unit (GPU)) provide graphics and video signals between the computer 902 and external display(s) 938 (e.g., LCD, plasma) and/or onboard displays 940 (e.g., for portable computer). The graphics interface(s) 936 can also be manufactured as part of the computer system board.

The computer 902 can operate in a networked environment (e.g., IP-based) using logical connections via a wired/wireless communications subsystem 942 to one or more networks and/or other computers. The other computers can include workstations, servers, routers, personal computers, microprocessor-based entertainment appliances, peer devices or other common network nodes, and typically include many or all of the elements described relative to the computer 902. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 902 connects to the network via a wired/wireless communication subsystem 942 (e.g., a network interface adapter, onboard transceiver subsystem, etc.) to communicate with wired/wireless networks, wired/wireless printers, wired/wireless input devices 944, and so on. The computer 902 can include a modem or other means for establishing communications over the network. In a networked environment, programs and data relative to the computer 902 can be stored in the remote memory/storage device, as is associated with a distributed system. It will be appreciated that the network connections shown are exemplary and other means of establishing a communications link between the computers can be used.

The computer 902 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related technology and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a personal entity preference model of a user accessed according to user notification criteria;
a selection component that selects content for each of the entities obtained from a search based on predicted relevance to the user notification criteria;
a notification component that sends the content to the user as notifications for presentation of the content; and
a microprocessor that executes computer-executable instructions associated with at least one of the preference model, the search component, or notification component.

2. The system of claim 1, wherein the personal entity preference model is automatically created based on user search history and temporal search behavior of the user.

3. The system of claim 1, wherein the notification component orders the notifications based on the predicted relevance.

4. The system of claim 1, wherein the notification component computes timing and frequency of the notifications based on the personal entity preference model and responses of the user.

5. The system of claim 1, wherein the personal entity preference model is updated based on user responses to content of the notifications.

6. The system of claim 1, wherein the notification component sends the notifications for automatic viewing in a user interface of a user device.

7. The system of claim 1, wherein the personal entity preference model enables identification of a specific entity to track.

8. A method, comprising acts of:
selecting entities of a personal entity preference model of a user based on user notification criteria;
searching for content related to the entities;
selecting content for each of the entities based on predicted relevance to the user notification criteria; and
sending the content to the user as notifications.

9. The method of claim 8, further comprising ordering the notifications based on the personal entity preference model.

10. The method of claim 8, further comprising automatically creating the personal entity preference model based on search history and temporal search behavior of the user.

11. The method of claim 8, further comprising computing timing and frequency of the notifications to the user based on the personal entity preference model.

12. The method of claim 8, further comprising updating the personal entity preference model using explicit and implicit user responses to same or different entities.

13. The method of claim 8, further comprising updating the personal entity preference model based on a user response to a notification.

14. The method of claim 8, further comprising automatically linking to the content for the entities on the user device via the notifications.

15. The method of claim 8, further comprising automatically presenting the content for the entities on the user device.

16. A computer-readable medium comprising computer-executable instructions that when executed by a processor, cause the processor to perform acts of:
selecting entities of a personal entity preference model of a user based on user notification criteria;
searching for content related to the entities;
selecting content for each of the entities based on predicted relevance to the user notification criteria;
computing timing and frequency of notifications to be sent to the user based on the personal entity preference model;
sending the content to the user as the notifications for presentation in a user interface based on the timing and frequency; and
presenting the notifications in an ordered manner.

17. The computer-readable medium of claim 16, further comprising automatically linking to the content for the entities via the notifications or automatically presenting the content for the entities on the user device.

18. The computer-readable medium of claim 16, further comprising automatically creating the personal entity preference model based on search history and temporal search behavior of the user.

19. The computer-readable medium of claim 16, further comprising updating the personal entity preference model using explicit and implicit user responses to same or different entities.

20. The computer-readable medium of claim 16, further comprising updating the personal entity preference model based on a user response to content of a notification.
